(19) United States
(12) Patent Application Publication
(10) Pub. No.: US 2013/0143054 A1
(43) Pub. Date: Jun. 6, 2013

(54) ELASTIC FILM FOR MAKING A DIAPER FASTENER

(71) Applicants: Henner SOLLMANN, Gronau (DE); Georg BALDAUF, Laer (DE)

(72) Inventors: Henner SOLLMANN, Gronau (DE); Georg BALDAUF, Laer (DE)

(21) Appl. No.: 13/684,752

(22) Filed: Nov. 26, 2012

(30) Foreign Application Priority Data
Dec. 5, 2011 (EP) 11191956.9

(51) Int. Cl. C08K 5/09; B29C 47/00; B29C 47/06; B32B 27/08

(52) U.S. Cl. CPC C08K 5/09; B32B 27/08; B29C 47/0004; B29C 47/065
USPC 428/497; 264/176.1; 264/174.11; 524/300; 428/500; 428/516

(57) ABSTRACT

An elastic film for making diapers. The film has an extruded elastic layer of a polymer comprised of a mixture of a styrene block copolymer and a plasticizer. the plasticizer is over 50% by weight of at least one vegetable-based oil.

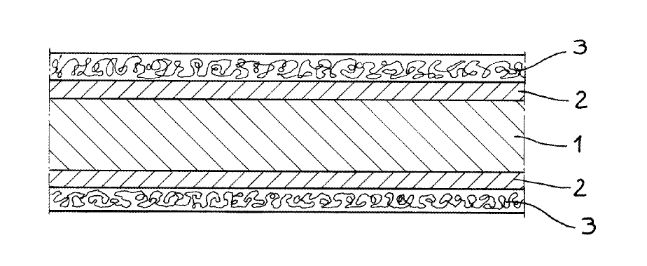

### FIELD OF THE INVENTION

The present invention relates to an elastic film. More particularly this invention concerns such a film with an extruded elastic layer of a polymer comprised of a mixture of a styrene block copolymer and a plasticizer used for making a diaper fastener.

### BACKGROUND OF THE INVENTION

A film for making diaper fasteners in the form of fastener tabs or elastic ears typically has at least one elastic layer of a thermoplastic elastomer. Thermoplastic elastomers are plastics that at room temperature behave in a comparable manner to classic elastomers, but when heated can be plastically deformed and thus have thermoplastic properties.

The film comprises an elastic layer that contains styrene block copolymers. These are two-phase systems that are composed of an elastic soft phase and a thermoplastic hard phase. The styrene blocks are composed of styrene units that preferably are connected to butadiene segments. In the case of styrene block polymers mineral oils are used as plasticizers in order to reduce hardness. The plasticizer absorption depends, among other things, on the grain structure of the polymer granules. With conventional plasticizers these are plasticizer oils that are based on petroleum. They are also referred to as white oils.

Petroleum is a fossil raw material that is becoming increasingly scarce. Furthermore, its production and processing lead to risks for the environment and contribute to global warming.

### OBJECTS OF THE INVENTION

It is therefore an object of the present invention to provide an improved elastic film for making a diaper fastener.

Another object is the provision of such an improved elastic film for making a diaper fastener that overcomes the above-given disadvantages, in particular that is inexpensive and distinguished by advantageous product properties when used as diaper fasteners. A high consumer acceptance should also be ensured.

### SUMMARY OF THE INVENTION

An elastic film for making diapers. The film has according to the invention an extruded elastic layer of a polymer comprised of a mixture of a styrene block copolymer and a plasticizer. The plasticizer is over 50% by weight of at least one vegetable-based oil.

The proportion of finite resources, such as petroleum, is reduced by replacing at least a part of the white oil by vegetable-based oils. Furthermore, the CO₂ footprint is improved. This contributes to sustainable production. With high crude oil prices, vegetable-based oils also have a cost advantage over white oils. They also have better odor properties.

The plasticizer is composed by more than 50% by weight of at least one vegetable oil, preferably more than 80% by weight. In a particularly advantageous embodiment of the invention, the plasticizer is composed entirely of at least one vegetable-based oil.

Plastics in which vegetable oils are used as plasticizers are known. For instance in WO 2000/066662 [U.S. Pat. No. 6,673,857] a thermoplastic elastomer composition is described that contains styrene block copolymers and a vegetable oil as plasticizer. The plastics are used to produce molded parts. An application of vegetable oils as plasticizers in the case of elastic films that are suitable for diapers and are used, for example, as elastic diaper fasteners has not yet been considered. This is due not least to the particularly high quality requirements that are set by the consumer for the product and use properties of baby products. Even slight deviations in the polymer composition thereby influence the quality of these films. Surprisingly, it was found that vegetable oils as plasticizers can have a positive influence on the product properties of elastic films for diaper fasteners. However, for this purpose a targeted selection of vegetable oils is necessary, since otherwise the complex process of film production for making diapers is influenced negatively.

Preferably, vegetable oils with an iodine number of less than 150, preferably less than 100, are used. The determination of the iodine number is an analytic method for detecting double bonds in oils, which is carried out according to standardized specifications. The iodine number is thereby the mass of iodine in grams that is bound by 100 g of a substance. In the selection of vegetable oils, oils with an iodine number of less than 150, preferably less than 100, have proven to be particularly suitable for making films for making diapers, since they have a particular stability to oxygen and UV radiation and a high thermal stability.

The smoke point has proven to be an additional or alternative selection criterion for the use of vegetable oils for making films for making diapers. The smoke point is also determined according to standardized specifications. This is the temperature at which the oil in the presence of air decomposes forming smoke. For film production for making diapers, vegetable oils are selected that have a smoke point of more than 180° C., in particular more than 200° C. Refined oils are particularly suitable thereby, since they have higher smoke points compared to non-refined oils.

As a further criterion for the selection of suitable vegetable oils, additionally or alternatively kinematic viscosity is used. It has been shown in tests that this has a decisive influence on the quality of the films produced for making diapers. Vegetable oils have thereby proven to be particularly advantageous which have a kinematic viscosity at 20° C. of less than 85 mm²/sec and more than 60 mm²/sec.

In particular the following vegetable oils are suitable as plasticizers in the polymer composition for the extrusion of an elastic layer: rapeseed oil, soybean oil, sunflower oil, corn germ oil, cottonseed oil, rice germ oil, peanut oil, olive oil, safflower oil. Refined vegetable oils are preferred. The above-mentioned oils can be used individually or in mixtures. In particular, they can also be used as a mixture with white oil, i.e. a plasticizer oil obtained on a petroleum basis, where the proportion of the vegetable oil according to the invention is at least 50% by weight based on the total quantity of the plasticizer used in the polymer composition.

Taking into consideration the previously listed selection criteria and in addition bearing in mind odor properties and influence on color, the use of refined rapeseed oil as plasticizer oil has proven to be particularly advantageous for films for making diapers.

The production of the film for making diapers takes place in several steps. First, the mixture of the styrene block copolymer and the vegetable plasticizer oil is produced. The plasticizer oil is thereby added to granules of the styrene block copolymer. The proportion of plasticizer in the mixture is thereby advantageously between 10% by weight and 60% by weight.

Preferably, the mixture contains a plasticizer proportion between 20% by weight and 40% by weight.

A high-molecular linear styrene butadiene styrene (SBS) block polymer is suitable as a styrene block copolymer. The mixture is stirred until the vegetable oil has been drawn into the polymer grains.

In a next step, further components are added to this mixture. The proportion of the mixture in the polymer composition is thereby preferably more than 30% by weight, in particular more than 40% by weight and less than 60% by weight, in particular less than 50% by weight. The polymer composition, i.e. the mixture and the further components, can be processed by a twin-screw extruder or compounder.

In an advantageous variant of the invention, the polymer composition, in addition to the styrene block copolymer proportion already present in the mixture, contains a proportion of a linear SBS block copolymer of more than 30% by weight and less than 60% by weight. Furthermore, it has proven to be favorable if the polymer composition contains more than 5% by weight and less than 30% by weight of a polystyrene. In an advantageous variant, moreover, thermal stabilizers are contained. Furthermore, further additives such as color pigments can be contained.

In a particularly advantageous embodiment of the invention, the film produced for making diapers has at least one cover layer coextruded with the polymer composition, preferably the elastic layer produced from the polymer composition being embedded between two cover layers. Adhesion of the film when rolled up is thus avoided. Polymers from the group polyethylene, polyethylene copolymers, polypropylene, polypropylene copolymers or a mixture of these polymers has proven to be favorable as a material for the cover layer. The polyolefinic outer layer is thereby preferably thin compared to the elastic layer. The thickness of the outer layer is less than 20%, in particular less than 10% of the thickness of the elastic layer.

With a particularly advantageous variant, at least one textile outer layer is laminated onto the film. The textile outer layer and the film can be bonded together in different ways. A preferred embodiment provides that the textile outer layer is adhered to the film with an adhesive applied over the entire surface or in a punctiform or strip-shaped pattern. Preferably, a nonwoven is used as a textile outer layer.

For use in making diapers, in particular for diaper fasteners, it is advantageous if the elastic film has tensile strength in one direction and is elastically expandable only transversely. To improve its elasticity, the film is mechanically activated before its use. During activation it is stretched in the desired tension direction, usually CD (“cross direction”) by means of stretch rollers.

### BRIEF DESCRIPTION OF THE DRAWING

The above and other objects, features, and advantages will become more readily apparent from the following description, reference being made to the accompanying drawing whose sole FIGURE is a large-scale section through the film according to the invention.

### DETAILED DESCRIPTION

As seen in the drawing a film for making a diaper fastener has a multilayered structure with an elastic center layer 1 embedded between two cover layers 2. The total thickness of the film is 60 μm. The cover layers 2 are composed of a polyethylene/polypropylene mixture and each have a thickness of 5 μm. A textile outer layer 3 of nonwoven is laminated onto each cover layer 2.

In the production of the film, in a first step a mixture of a styrene block copolymer and a vegetable plasticizer oil is produced. In particular the following vegetable oils are considered as a plasticizer oil: rapeseed oil, sunflower oil, corn germ oil, soybean oil, cottonseed oil, rice germ oil, peanut oil, olive oil and safflower oil. Refined vegetable oils are preferred.

The plasticizer oil is selected according to several criteria, so that it meets the high demands on a film for diaper fasteners. Table 1 lists substance properties that are used as selection criteria for the use of the vegetable oil as plasticizer.

TABLE 1
Selection criteria for different process oils

| | Rapeseed | Sunflower | Corn germ | Soybean | Cottonseed | Rice germ | Peanut | Olive | Safflower |
|---|---|---|---|---|---|---|---|---|---|
| | oil | oil | oil | oil | oil | oil | oil | oil | oil |
| Iodine | 105-115 | 120-140 | 107-130 | 120-141 | 105-115 | 92-115 | 80-107 | 75-90 | 138-152 |
| number | | | | | | | | | |
| Kinematic | 74 | 65.8 | 64.1 | 63.5 | 65 | 76 | 80.4 | 83.8 | 65.8 |
| viscosity | | | | | | | | | |
| at 20° C. | | | | | | | | | |
| (in mm²/sec) | | | | | | | | | |
| Color | Brownish | Yellow | Light to | Light | Light | Light | Yellowish | Light | Light |
| | yellow | | golden | yellow | yellow | yellow | | yellow | yellow |
| | | | yellow | | | | | | |
| Odor | Weakly of | Weakly of | Weakly of | Weakly of | Weakly of | Weakly of | Weakly of | Weakly of | Weakly of |
| | vegetable | vegetable | vegetable | vegetable | vegetable | vegetable | vegetable | vegetable | vegetable |
| | oil | oil | oil | oil | oil | oil | oil | oil | oil |
| Melting | −5° C. | −18° C. | −18° C. | −15° C. | −2° C. | −5° C. to | −2° C. | Approx. | −5° C. |
| point | | to −16° C. | to −10° C. | to −8° C. | | 10° C. | | 0° C. | |
| Smoke | >200° C. | Approx. | Approx. | Approx. | 216° C. | Approx. | 200-235° C. | 230° C. | >200° C. |
| point | | 220° C. | 220° C. | 234° C. | | 254° C. | | | |

With the production of films for diaper fasteners, oils with the following substance properties have proven to be particularly advantageous:
An iodine number of less than 150, preferably less than 120,
A smoke point of more than 180° C., in particular more than 200° C.,
A kinematic viscosity at 20° C. of less than 85 mm²/sec and more than 60 mm²/sec,
A pleasant odor,
The palest possible color.

With the application of these criteria for selecting a plasticizer oil, among other things refined rapeseed oil has proven to be favorable.

In a first production step, a mixture of a styrene block copolymer and a vegetable oil is produced. Mixtures of a styrene block copolymer in combination with different vegetable oils are listed in table 2. A high molecular linear styrene-butadiene-styrene (SBS) is used as a styrene block copolymer.

TABLE 2
Different mixtures

| Raw material [% by weight] | V1 | V2 | V3 | V4 | V5 | V6 |
|---|---|---|---|---|---|---|
| High molecular linear SBS | 70 | 70 | 70 | 70 | 70 | 70 |
| block copolymer | | | | | | |
| White oil | 30 | — | — | — | | |
| Peanut oil | — | 30 | — | — | | |
| Corn germ oil | — | — | 30 | — | | |
| Rapeseed oil | — | — | — | 30 | | |
| Soybean oil | — | — | — | — | 30 | — |
| Sunflower oil | — | — | — | — | — | 30 |

The mixtures V2 through V6 have a proportion of a styrene block copolymer of 70% by weight in combination with 30% by weight plasticizer oil. The first mixture V1 is a conventional mixture with a white oil. This serves as a reference.

Table 3 shows that in the tests with the vegetable oils a lower torque occurs with the production of the mixture using a kneader and thus a lower energy expenditure during production is necessary.

TABLE 3

| | Maximum | Torque at | Maximum temperature |
|---|---|---|---|
| | torque | end of test | (in ° C.) |
| | (in Nm) | (in Nm) | at end of test |
| White oil | 10.8 | 5.2 | 187.9 |
| Peanut oil | 8.3 | 4.9 | 186.3 |
| Cottonseed oil | 8.1 | 4.7 | 186.7 |
| Corn germ oil | 8.0 | 4.5 | 187.6 |
| Olive oil | 8.0 | 3.6 | 186.1 |
| Rapeseed oil | 8.3 | 4.2 | 187.2 |
| Rice germ oil | 7.7 | 4.3 | 186.7 |
| Safflower oil | 7.0 | 4.1 | 187.1 |
| Soybean oil | 7.3 | 4.3 | 186.7 |
| Sunflower oil | 7.9 | 3.8 | 187.4 |

After the production of the mixture, the polymer composition is produced in a next step.

Table 4 shows the constituents of a polymer composition.

TABLE 4
Polymer composition

| | Quantity |
|---|---|
| Raw material | (in % by weight % |
| Mixture of styrene block copolymer | 50 |
| and plasticizer oil (70/30 blend) | |
| Linear SBS block copolymer | 40 |
| Polystyrene | 10 |

The polymer composition contains 50% by weight of the mixture of a styrene block copolymer and a plasticizer. A linear styrene-butadiene-styrene (SBS) copolymer is added to the mixture, the proportion of which in the polymer composition is 40% by weight. Furthermore, 10% by weight polystyrene is added. Thermal stabilizers are likewise present.

Table 5 shows the torque and the material pressure during the compounding of the polymer composition in a twin-screw extruder.

TABLE 5
Torque and material pressure during compounding

| Compound | Torque (scale in %) | Material pressure (in bar) |
|---|---|---|
| White oil | 48 | 22 |
| Peanut oil | 45 | 20 |
| Sunflower oil | 44 | 21 |
| Corn germ oil | 44 | 19 |
| Rapeseed oil | 44 | 19 |
| Sunflower oil | 43 | 19 |
| Soybean oil | 42 | 20 |

It has been shown that the torque and the material pressure during the compounding of the polymer mixture are lower with the use of vegetable oils than with the use of white oil. A lower energy expenditure is thus necessary here too during processing.

The compound is used for the core layer of a multilayered film produced by coextrusion. The multilayered film has on both sides of the core layer an outer layer 5 μm thick of a polyethylene/polypropylene mixture and has a total thickness of 60 μm. The multilayered films produced using the above-described compound are subjected to an odor comparison. The tests are carried out based on DIN 10955 and VDA 270. The evaluation is carried out according to intensity 1 through 10 and according to the effect of the odor from −4 to +4. The results of the odor test are listed in Table 6.

TABLE 6
Odor test

| | Odor effect | Odor intensity |
|---|---|---|
| White oil | −1 | 5 |
| Corn germ oil | 0.1 | 3.4 |
| Rapeseed oil | 0.6 | 3.8 |
| Sunflower oil | 0.6 | 4.6 |
| Soybean oil | 0.8 | 4.4 |

The films produced with the selected vegetable oils perform better in odor effect as well as in odor intensity than the films produced with white oil.

Elastic films that made according to the invention using refined vegetable oils as plasticizer are suitable for making diapers and can be used as diaper fasteners. The replacement of a petroleum-based white oil by a vegetable oil does not have a disadvantageous effect on the elasticity of the film. An elastic film that according to the invention contains a vegetable oil as a plasticizer tends to be somewhat softer than a film produced with white oil. Films produced using rapeseed oil are also distinguished after an elastic expansion by a low residual expansion. Rapeseed oil is therefore the preferred vegetable oil within the scope of the teaching according to the invention.

We claim:

1. An elastic film for making diapers, the film comprising:
an extruded elastic layer of a polymer comprised of a mixture of a styrene block copolymer and a plasticizer, the plasticizer being over 50% by weight of at least one vegetable-based oil.

2. The elastic film defined in claim 1, wherein the plasticizer is composed entirely of at least one vegetable-based oil.

3. The elastic film defined in claim 1, wherein the vegetable-based oil has
an iodine number of less than 150, in particular less than 120, and/or
a smoke point of more than 180° C., in particular more than 200° C., and/or
a kinematic viscosity at 20° C. of less than 85 mm²/sec and more than 60 mm²/sec.

4. The elastic film defined in claim 1, wherein the vegetable-based oil is rapeseed oil, soybean oil, sunflower oil, corn germ oil, cottonseed oil, rice germ oil, peanut oil, olive oil, or safflower oil.

5. The elastic film defined in claim 1, wherein rapeseed oil is used as the vegetable-based oil.

6. The elastic film defined in claim 1 wherein the plasticizer is more than 10% by weight and less than 60% by weight of the mixture.

7. The elastic film defined in claim 6, wherein the plasticizer is more than 20% by weight and less than 40% by weight of the mixture.

8. The elastic film defined in claim 1, wherein the polymer composition is more than 30% by weight and less than 60% by weight of the mixture.

9. The elastic film defined in claim 1, wherein the polymer composition is more than 40% by weight and less than 50% by weight of the mixture.

10. The elastic film defined in claim 1, wherein the polymer composition also includes, in addition to the styrene block copolymer proportion, a linear SBS block copolymer comprising 30% to 60% by weight of the mixture.

11. The elastic film defined in claim 1, wherein the polymer composition comprises more than 5% by weight and less than 30% by weight of a polystyrene.

12. The elastic film defined in claim 1, further comprising:
at least one cover layer coextruded with the polymer composition.

13. The elastic film defined in claim 12, wherein the coextruded cover layer is composed of polyethylene, polyethylene copolymers, polypropylene, polypropylene copolymers or a mixture thereof.

14. A method for making an elastic film for making a diaper fastener, the method comprising the step of:
extruding at least one elastic layer from a polymer comprised of a styrene block copolymer and a plasticizer, the plasticizer being composed of over 50% by weight of at least one vegetable-based oil.

15. The method defined in claim 14, wherein the polymer is coextruded with at least one cover layer.

16. The method defined in claim 15 wherein the cover layer is composed of polyethylene, polyethylene copolymer, polypropylene, polypropylene copolymer or a mixture thereof.
